(19) United States
(12) Patent Application Publication
(10) Pub. No.: US 2002/0195004 A1
(43) Pub. Date: Dec. 26, 2002

(54) Portable truss fabrication apparatus and method

(76) Inventor: Charles A. Mead, Gulfport, MS (US)

Correspondence Address: MICHAEL D CARBO, PLC, 700 WHITNEY BANK BUILDING, 228 ST CHARLES AVENUE, NEW ORLEANS, LA, 70130, US

(21) Appl. No.: 09/887,579

(22) Filed: Jun. 22, 2001

(51) Int. Cl. B30B 1/32

(52) U.S. Cl. 100/35; 100/100; 100/231; 100/269.08; 100/913; 29/432; 29/798; 269/910; 227/152

(57) ABSTRACT

A portable apparatus for fabricating or repairing trusses, rafters, joints, and splices by pressing the barbs of a barbed connector plate into the lumber to be joined or spliced. The apparatus has generally C-shaped press yoke with a first end portion, a body, and second end portion defining an internally threaded slot for receiving an externally threaded portion of a hydraulically actuated press; a first platen positionable at and removably attachable to the first end portion of the press yoke; a hydraulically actuated press with an externally threaded body and a plunger, the body being connected to the second end portion by screwing the thread of the body into the second end portion with the plunger passing through the slot of the second end portion; a second platen removably attachable to an end of the plunger; a pneumatically powered hydraulic pump connected to the press for powering the plunger to press the second platen toward the first platen; and preferably a jack stand, a jack arm support, and a telescoping sleeve actuatable by a cable and pulley system mounted on the jack arm support. Preferably, the platens have magnets inset into their working sides. A method of fabricating or repairing trusses, rafters, joints, and splices includes employment of the apparatus, preferably at the work site where the truss, rafter, joint, or splice is to be used. Preferably one or both of the pieces of lumber to be joined or spliced are joined in situ where the joined pieces of lumber are to be used.

### CROSS-REFERENCE TO RELATED APPLICATIONS

Not applicable.

### COPYRIGHT STATEMENT

Not applicable

### FEDERAL RESEARCH STATEMENT

Not applicable.

### BACKGROUND OF THE INVENTION

1. Field of the Invention

The invention relates generally to the fabrication of trusses, rafters, and wood splices, and more particularly to apparatus and methods for fabricating trusses or similar building components in situ or otherwise at a construction or repair site. Pieces of lumber are joined together by pressing the barbs of a barbed connector plate (also known as nail plate) into lumber to be joined or spliced. Nail plates are formed from sheet metal and are intended to be used for the same purposes as braces and truss-component connectors. Nail plates provide several advantages over separately nailing braces and plates to lumber to be joined or repaired.

The invention also relates to a new and improved press whereby precut parts for the manufacture of building components such as wall panels, roof supports, and girder truss members, can be joined by application of fluid pressure such as air, through a hydraulic cylinder. The invention particularly concerns apparatus and methods facilitating very rapid and efficient assembly or repair of roof rafters, truss chords and web members, and other lumber to be joined or spliced.

There is a constant need or requirement for reducing the expense and cost of fabrication of roof rafters and trusses, and for allowing wood joints to be repaired in situ. A large portion of this cost has been due to necessary labor involved in laying out the truss components and then connecting them. This procedure is time consuming and expensive, and often the resultant trusses were not sufficiently integrally formed. Further, trusses are often fabricated off-site because the truss fabrication equipment is not portable and is not conveniently able to be used at the specific site or location of a repair or construction, thereby causing increased transportation expense, particularly by oversized loads.

2. Description of the Prior Art

A primary method of joining building components in the assembly of wall and roof sections and trusses has been by nailing, with each joint nailed separately by hand. This procedure has been modified to some extent in recent years by placing the component parts in a jig or tight frame, and then nailing the parts together with a hammer and nail or with pneumatic guns. Some housing components such as roof trusses are manufactured off-site by pressing flat steel plates with attached protrusions or teeth into the wood where the material is to be joined, either by using fluid activated cylinders or truss rollers. Wall sections are typically built by using pneumatic guns positioned at each joint and the nails forced into the wood, either one at a time or simultaneously using a group of pneumatic guns, each of which is positioned at a specific joint. In the case of truss construction, where steel plates are used, the nailing must still be accomplished for the most part by hand, or with complicated truss rollers or other equipment designed to place considerable pressure at specifically designated points on the component parts of the truss or other member to achieve a tight fit. Pneumatic guns break down or run out of fasteners, which slows production, and truss rollers are slow and frequently produce trusses of poor quality. Accordingly, such techniques are characterized by high expense and expenditure of a large amount of time, whether the structure being built is assembled piecemeal and nailed by a carpenter, fastened by use of pneumatic guns, or by use of “gang” nail procedures.

In recent years there has developed a renewed interest in building wooden trusses in both home and commercial building because of the rapidly escalating cost of steel. It has been found that wooden trusses are highly reliable, relatively inexpensive, and easily and quickly fabricated for a wide variety of building configurations. Speed and quality are necessary ingredients in truss production operations; accordingly, the equipment used in the manufacture the trusses must be highly reliable and capable of assembling trusses rapidly and efficiently.

U.S. Pat. No. 4,184,621 to Epes discloses a building press for joining building components, including building trusses, by using hammers to force nail plates into building components, and, alternatively, applying hydraulic pressure on hydraulic cylinders. The building press disclosed in Epes is not particularly portable and cannot be readily positioned at a building site to fabricate a truss on site or in the precise location where it will be used in construction.

U.S. Pat. No. 3,908,885 to Scott discloses a roof truss fabrication apparatus that presses barbed connector plates into joined chord and web members. The apparatus disclosed in Scott is bolted to carriages which are supported on horizontal parallel rails. The apparatus disclosed in Scott is not portable and is not suitable for truss or joist construction or repair at a construction site or in situ.

Similarly, U.S. Pat. No. 3,837,274 to Zaccard discloses a device for locating a nail plate on a flat, magnetic platen of a clamping apparatus. The clamping apparatus has a pair of movable platens which, when actuated, press the nail plate into lumber placed between the platens. The apparatus disclosed in Zaccard is mounted on rails, thereby rendering it unsuitable for portable applications on site and for in situ construction or repair.

U.S. Pat. No. 3,939,548 to Jureit, et al. discloses a conveyor table having press heads mounted on opposite sides. Once again, there is no semblance of portability disclosed therein. There remains a need for an improved portable truss, rafter, joint, and wood splice fabrication and repair apparatus that allows for use at the specific location of construction of a structure in which a truss, rafter, joint, or splice is placed, and allows the repair of a truss, rafter, joint, or splice in situ.

### SUMMARY OF INVENTION

It is an object of the present invention to provide an apparatus and method overcoming the above problems, as well as providing additional advantages to be shown. Basically, the apparatus operates to fabricate or repair trusses, rafters, joints, and splices by pressing the barbs of a barbed connector plate into lumber to be fabricated into trusses or rafters, or to be joined or spliced, and includes:

(a) a press yoke defining generally a C-shape having a first end portion, a body portion, and a second end portion, the second end portion defining an internally threaded slot for receiving in connecting engagement an externally threaded portion of a hydraulically actuated press;

(b) a first platen swivelably positionable at and removably attachable to the first end portion of the press yoke;

(c) a hydraulically actuated press comprising a body and a plunger, the body having external threads and the body being connected to the second end portion by screwing the threads of the body into the second end portion with the plunger passing through the slot of the second end portion;

(d) a second platen, removably attachable to an end of the plunger; and

(e) a pneumatically powered hydraulic pump connected to the press for powering the plunger to press the second platen toward the first platen, thereby clamping the barbed connector plate into lumber to be joined or spliced.

As will be seen, the press yoke may be sized to allow the development of approximately 40,000 or more pounds of pressure with a three-times safety factor when used with a 25-ton press and an 8″ by 10″ barbed connector plate.

The apparatus is portable and able to be positioned and supported to repair or fabricate trusses and rafters in place.

### BRIEF DESCRIPTION OF THE DRAWINGS

The invention will be better understood in view of the following description presented with reference to the accompanying drawing, wherein:

FIG. 1 is an overall schematic view of the invention;

FIG. 2 is a top view of the press yoke;

FIG. 3 is a bottom view of the press yoke; and

FIG. 4 is a side schematic view of the positioning and supporting apparatus according to the claimed invention.

### DETAILED DESCRIPTION OF THE INVENTION

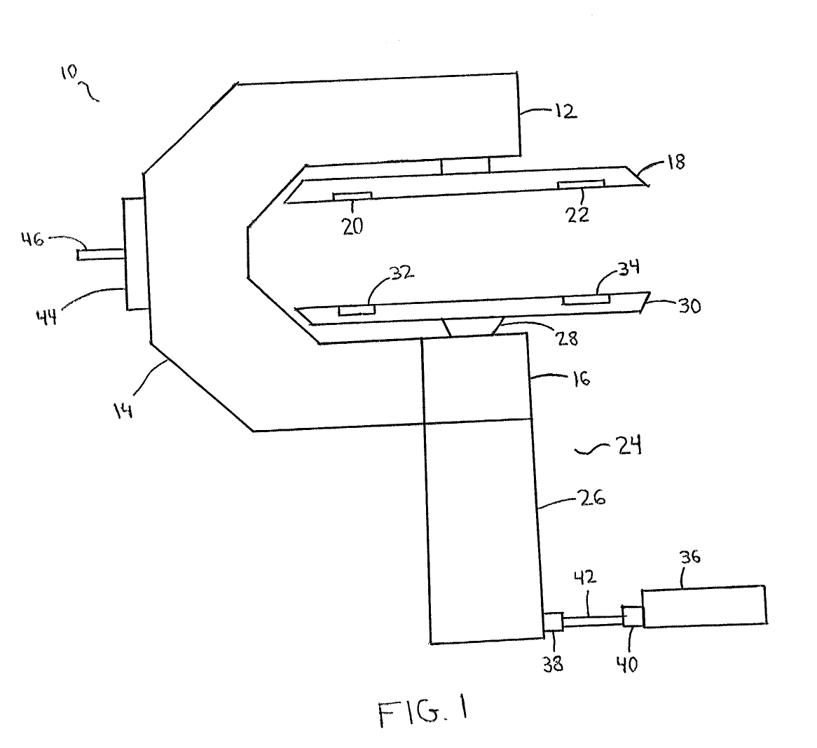

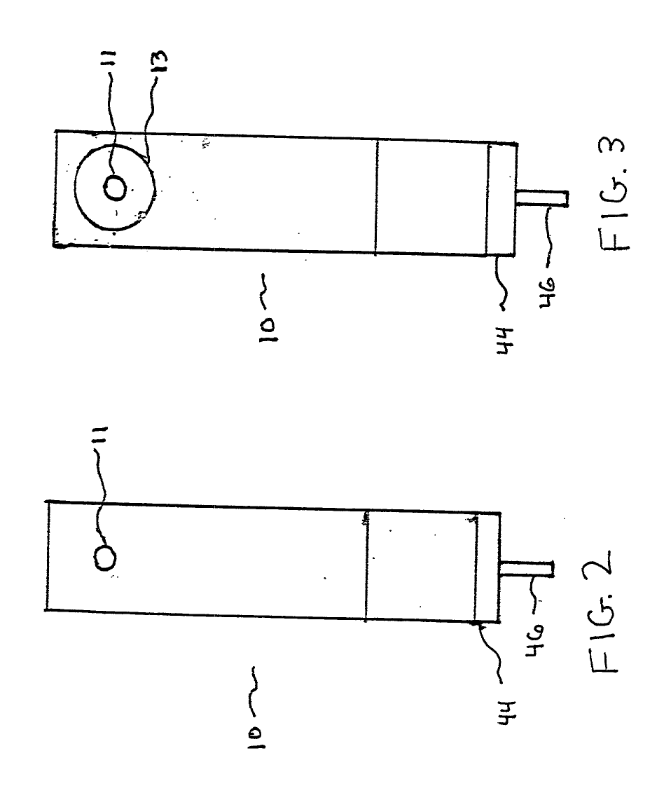

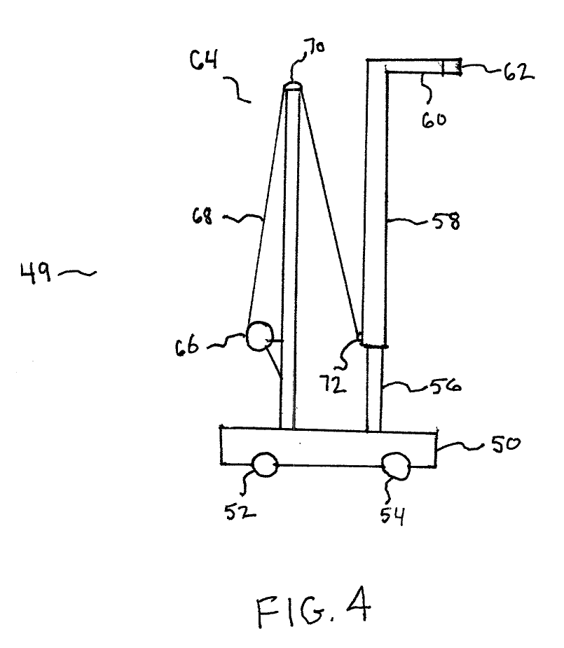

Referring first to FIG. 1, press yoke 10 defines generally a C-shape having first end portion 12, body portion 14, and second end portion 16. Positioned at and removably attached to first end portion 12 is first platen 18. First platen 18 is equipped with magnets 20 and 22 countersunk into platen 18 to allow an iron or steel barbed connector (not shown) to be held in position against platen 18 during a clamping or pressing operation. Hydraulic press 24 includes body 26 and plunger 28. Second platen 30 has magnets 32 and 34 countersunk into a working surface of platen 30 and is similar to the arrangement and configuration of platen 18. Second platen 30 is removably attachable to plunger 28. Hydraulic press 24 has exterior threads on its body near the end where plunger 28 protrudes. The external threads of the body of press 26 are screwed into mating threads of internally threaded slot 13, as shown in FIG. 3. Pneumatically powered hydraulic pump 36 is connected to press 26 via ¼″ swivel connectors 38 and 40, by means of hose 42.

Referring to FIG. 4, positioning and supporting apparatus 49 (also known as a jack) includes jack stand 50 having wheels 52 and 54. Jack arm support 56 mounted on jack stand 50 includes telescoping sleeve 58. Connected to telescoping sleeve 58 is jack arm 60 having mounting point 62 for attaching press yoke 10 to positioning and supporting apparatus 49 via a pin and socket connection. Winch-activated pulley system 64 includes winch 66, cable 68, and cable guide 70, and connects to telescoping sleeve 58 at cable attachment 72.

In operation, press yoke 10 is mounted onto jack arm 60 at mounting point 62 via a pin connection, comprising mounting plate 44 and pin 46, in order to allow press yoke 10 to pivot and to be placed in a location where a truss or rafter is to be fabricated or repaired. Winch 66 is operated to raise and lower telescoping sleeve 58 on jack arm support 56 to gain any vertical height necessary for positioning press yoke 10.

In operation, internally threaded slot 13, preferably having 12 threads to the inch and being 2¼″ in depth, has screwed thereinto the externally threaded portion of body 26 of hydraulic press 24. First platen 18 is preferably square or rectangular and can vary in size from approximately 2″ by 4″ to 8″ by 10″. First platen 18 is preferably swivelably positioned and attached via a key attachment to first end portion 12 of press yoke 10. Second platen 30 is mounted on plunger 28 so that when plunger 28 is extended out of the body of press 24, platens 18 and 30 move toward each other and press or clamp any material between the platens. Working pieces of lumber to be fabricated or repaired are placed adjacent to each other within the space defined by platens 18 and 30. One or more barbed connectors are placed on either or both sides of the working pieces to overlap the pieces. When press 24 is actuated by pump 36, plunger 28 extends from body 26 of press 24, thereby pressing the barbed portion of the barbed connectors into the working pieces to fabricate or repair a truss, rafter, joint, or splice.

Press yoke 10 preferably has an 8″ yoke and a 4¼″ throat, and is sized to have a 40,000 pounds capacity with a three to one safety factor when used with a 25,000 pound press and 8″ by 10″ barbed connector plates, or a 20,000 pound capacity when used with a 10-ton press and 4″ by 6″ barbed connector plates.

Press 26 is preferably a Power Team 25-ton, number C254C, model B press (SPX Corporation, Owatonna, Minn.). A 25-ton press can press rectangular plates up to approximately 8″ by 10″ in area. A 10-ton press can be used to press rectangular plates up to approximately 4″ by 6″ in area.

Pursuant to some local building codes, nails for joint plates must be arranged in a two-inch square pattern. Using barbed connector plates pressed into the working pieces to fabricate or repair rafters and trusses, joints and splices can be rapidly and efficiently made.

Press yoke 10 can be attached to jack stand 49 so that press yoke 10 moves with jack stand 49 when it is rolled into position under working pieces. Press yoke 10 can be positioned so that the platens surround the working pieces by means of the winch-actuated cable and pulley system mounted on the jack stand. Jack stand 49 is sized so that when collapsed it is no more than approximately 78″ in height, and is no more than approximately 11′ when extended.

Preferably, hydraulic pump 36 is powered by a portable gasoline powered air compressor.

1. Apparatus for fabricating or repairing trusses, rafters, joints, and splices by pressing the barbs of a barbed connector plate into lumber to be fabricated, repaired, joined or spliced, the apparatus comprising:
(a) a press yoke defining generally a C-shape having a first end portion, a body portion, and a second end portion, the second end portion defining an internally threaded slot for receiving in connecting engagement an externally threaded portion of a hydraulically actuated press;
(b) a first platen positionable at and removably attachable to the first end portion of the press yoke;
(c) a hydraulically actuated press comprising a body and a plunger, the body having external threads, and the body being connected to the second end portion by screwing the threads of the body into the second end portion with the plunger passing through the slot of the second end portion;
(d) a second platen, positionable at and removably attachable to an end of the plunger;
(e) a pneumatically powered hydraulic pump connected to the press for powering the plunger to press the second platen toward the first platen, thereby pressing the barbed connector plate into lumber to be fabricated, repaired, joined, or spliced.

2. The apparatus according to claim 1, wherein the press yoke slot internal threads are sized at twelve threads per inch and extend at least approximately 2¼″ through the slot.

3. The apparatus according to claim 1, wherein the first platen is rectangular, has dimensions of between approximately 2″ by 4″ and approximately 8″ by 10″, and is attached to the first end portion by keying means.

4. The apparatus according to claim 1, wherein the magnets are inset into the working side of at least one of the platens to hold the barbed connector plate on the at least one platen during clamping.

5. The apparatus according to claim 1, wherein the press yoke has approximately an 8″ yoke and approximately a 4¼″ throat, and is sized to develop approximately 40,000 pounds or more of pressure with a 3-times safety factor when used with a 25-ton press and an 8″ by 10″ barbed connector plate.

6. The apparatus according to claim 1, wherein the press yoke has approximately an 8″ yoke and approximately a 4¼″ throat, and is sized to develop approximately 20,000 pounds of pressure when used with a 10-ton press and a 4″ by 6″ barbed connector plate.

7. The apparatus according to claim 1, further comprising:
(f) means for positioning and supporting the press yoke in engagement with a truss, rafter, or other lumber to be fabricated, repaired, joined, or spliced.

8. The apparatus according to claim 7, wherein the positioning and supporting apparatus comprises:
(a) a jack stand having means for rolling or sliding the jack stand on a substantially horizontal surface;
(b) a jack arm support, connected to the jack stand, the jack arm support having a telescoping sleeve actuatable by a winch-actuated cable and pulley system;
(c) a winch-actuated cable and pulley system mounted on or near the jack arm support for actuating the sleeve; and
(d) a jack arm, connected to the jack arm support for receiving the press yoke and positioning and supporting the press yoke.

9. A method for fabricating or repairing trusses, rafters, joints, and splices, the method comprising: joining or splicing two pieces of lumber by clamping a barbed connector plate into the two pieces of lumber, by means of an apparatus comprising:
(a) a press yoke defining generally a C-shape having a first end portion, a body portion, and a second end portion, the second end portion defining an internally threaded slot for receiving in connecting engagement an externally threaded portion of a hydraulically actuated press;
(b) a first platen positionable at and removably attachable to the first end portion of the press yoke;
(c) a hydraulically actuated press comprising a body and a plunger, the body having external threads, and the body being connected to the second end portion by screwing the threads of the body into the second end portion with the plunger passing through the slot of the second end portion;
(d) a second platen, removably attachable to an end of the plunger;
(e) a pneumatically powered hydraulic pump connected to the press for powering the plunger to move the second platen toward the first platen thereby pressing the barbed connector plate into lumber to be fabricated, repaired, joined, or spliced.

10. A method for fabricating trusses, rafters, joints, and splices, according to claim 9, wherein the pressing operation is performed at the work site where the joined pieces of lumber are to be used.

11. A method for fabricating trusses, rafters and splices according to claim 9, wherein at least one or both of the pieces of lumber to be joined or spliced is attached to the structure in which the piece of lumber is to be employed before the joining or splicing operation is performed.
